(19) United States
(12) Patent Application Publication
(10) Pub. No.: US 2005/0010877 A1
(43) Pub. Date: Jan. 13, 2005

(54) System and method for dynamic generation of a graphical user interface

(76) Inventor: Arthur Udler, Pittsburgh, PA (US)

Correspondence Address: FISH & RICHARDSON P.C., 5000 BANK ONE CENTER, 1717 MAIN STREET, DALLAS, TX, 75201, US

(21) Appl. No.: 10/888,154

(22) Filed: Jul. 9, 2004

Related U.S. Application Data
(60) Provisional application No. 60/486,820, filed on Jul. 11, 2003.

(51) Int. Cl. G09G 5/00

(52) U.S. Cl. 715/826; 715/763; 715/744; 715/747; 345/581

(57) ABSTRACT

A system and method are provided for dynamic generation of a graphical user interface (GUI). In one embodiment, a method for dynamically generating a GUI includes selecting a GUI profile from a GUI descriptor file based on a client request, the GUI profile comprising at least one descriptor element. A GUI is automatically generated based on at least a portion of the selected GUI profile. The GUI is populated with data based, at least in part, on the client request.

### RELATED APPLICATION

This application claims the priority under 35 U.S.C. §119 of provisional application Ser. No. 60/486,820 filed Jul. 11, 2003.

### TECHNICAL FIELD

This disclosure relates generally to the field of data processing, and more particularly to a system and method for dynamic generation of a graphical user interface.

### BACKGROUND

Current data providers typically provide display parameters with the requested data. These display parameters include title, icons, chart format, various links, and other information used to present data to a client in a more readable form. Typically, the client, after receiving information, generates this presentation, which is not dynamically constructed. Further, conventional systems normally require that the data provider concurrently provides the data and the display parameters.

### SUMMARY

A system and method are provided for dynamic generation of a graphical user interface (GUI). In one embodiment, a method for dynamically generating a GUI includes selecting a GUI profile from a GUI descriptor file based on a client request, the GUI profile comprising at least one descriptor element. A GUI is automatically generated based on at least a portion of the selected GUI profile. The GUI is populated with data based, at least in part, on the client request. The details of one or more embodiments of the disclosure are set forth in the accompanying drawings and the description below. Particular features, objects, and advantages of the disclosure will be apparent from the description and drawings and from the claims.

### BRIEF DESCRIPTION OF THE DRAWINGS

FIG. 1 is a block diagram illustrating one embodiment of a system for dynamic generation of a graphical user interface (GUI) using a GUI profile;

FIGS. 2A-G illustrate various embodiments of a dynamically constructed GUI presented by the system in FIG. 1; and

FIG. 3 is a flowchart illustrating an example method for dynamic generation of a GUI using a GUI profile.

### DESCRIPTION OF EXAMPLE EMBODIMENTS

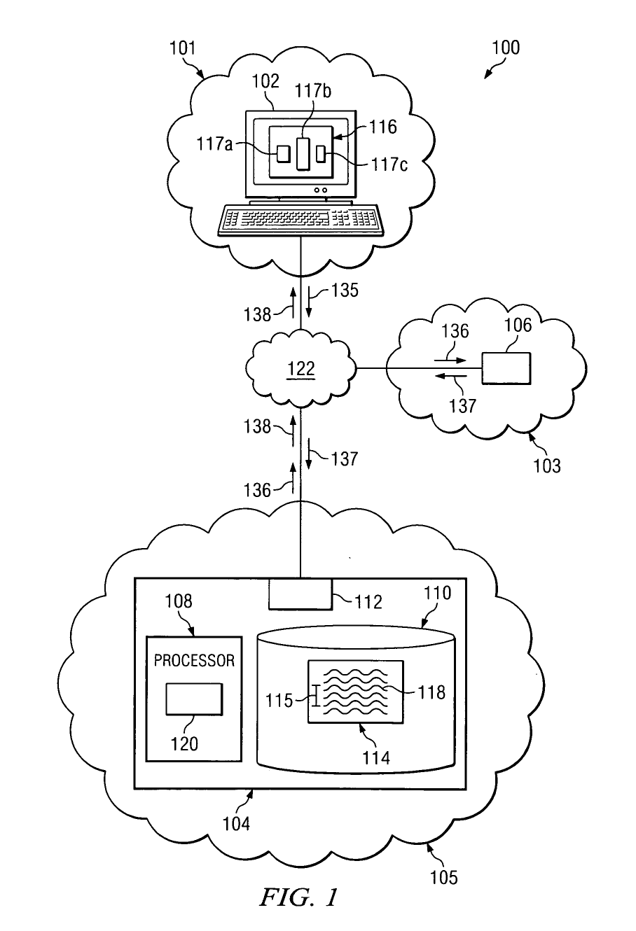

FIG. 1 illustrates one embodiment of a communication system 100 for dynamically formatting a data display using a graphical user interface (GUI) descriptor file 114. At a high level, communication includes a client system 101, a data provider system 103, and a server system 105 coupled via a network 122. Each system 101, 103, and 105 may be linked to network 122 via a plurality of discrete wireless and/or wireline links.

Network 122 communicates information between source and destination point. The sources and/or destination may be in network 122 or external to the network. Within the network, information may be communicated on wireless and/or wireline links between network devices. Network 122 may include one or more subnetworks, LANs, radio access networks (RANs), metropolitan area networks (MANs), wide area networks (WANs), all or a portion of the global network known as the internet, and/or any other communication system or systems at one or more locations. Network 122 may communicate, for example, internet protocol (IP) packets, frame relaying frames, a synchronous transfer mode (ATM) cells, voice, video, data, and other suitable information between network addresses. It will be understood that network 122 may comprise TCP/IP, IPX, SNA, DEL net, or other suitable networks.

Client system 101 makes request to network 122. Client system 101 may query, receive data or executables store and process requested data or executables, and communicate via network 122. While client system 101 is illustrated as disparate from network 122, network 122 may include client system 101. Client system 101 may comprise a plurality of network devices operable to communicate request to server system 105 via network 122. For example, client system 101 may comprise a plurality of workstations or other computing devices. In the illustrated embodiment, client system 101 includes an example client 102.

Client 102 includes, at least, a graphical user interface (GUI) 116. In general, client 102 may include input devices, output devices, mass storage media, processors, memory, interfaces, communication ports, or other suitable components for communicating client requests 135 to server system 105 and presenting the generated output to a user. Client requests 135 may include a GUI identifier (ID) operable to identify a GUI profile 115 stored in server system 105, data source information, contextual information, and/or any other suitable request information. Data source information may allow server system 105 to retrieve data requested by client 102. In the illustrated embodiment, data source information comprises, in part, an Internet Protocol (IP) address. In one embodiment, client requests 135 are transmitted to server system 105 via a hyperlink. Contextual information may be used for both generating GUI 116 and retrieving data from data provider 106. It will be understood that there may be any number of clients 102 coupled to server system 105. As used in this document, client 102 is intended to encompass a personal computer, work station, network computer, kiosk, wireless data port, personal data assistant (PDA), one or more processors within these devices or other devices, or any other suitable processing device. Moreover, “client 102” and “user of client 102” may be used interchangeably without departing from the scope of this disclosure. For example, client 102 may comprise a computer that includes an input device, such as a keypad, touch screen, mouse, or other suitable device that can accept information and an output device that conveys information associated with the operation of server 104 or clients 102, including digital data, visual information, or GUI profiles 115. Both the input device and output device may include fixed or removable storage media such as a magnetic computer disk, CD-ROM, or other suitable media to both retrieve input from and provide output to users of clients 102 through a portion of the data display, namely GUI 116.

GUI 116 comprises a graphical user interface operable to allow the user of client 102 to interface with system 100 to retrieve data from data provider 106. It will be understood that the term GUI, where appropriate, refers to the executable code for GUI 116 or substantially all of the executable code for GUI 116. Generally, GUI 116 provides the user of client 102 with an efficient and user-friendly presentation of data provided by system 100, such as charts, tables, or other graphical elements 117. In general, GUI 116 includes one or more graphical elements 117. Each graphical element 117 may include but is not limited to a frame, table, list, tree, grid, table, title, tab, tree item, text box, check box, button, table item, list item, scroll bar, a combination of the foregoing, or other suitable visual components. “Each,” as used herein, means every one of at least a subset of the identified items. GUI 116 may comprise a plurality of displays having interactive fields, pull-down lists, and buttons operated by the user. In one example, GUI 116 presents multiple charts and tables dynamically formatted by server 104 and receives commands from client 102. It should be understood that the term graphical user interface may be used in the singular or in the plural to describe one or more graphical user interfaces and each of the displays of a particular graphical user interface. Further, GUI 116 contemplates any graphical user interface, such as a generic web browser, that processes information in system 100 and efficiently presents the information to the user. Server 104 can accept data from client 102 via the web browser (e.g., Microsoft Internet Explorer or Netscape Navigator) and return the appropriate GUI 116.

Data provider system 103 provides data to network 122. Data provider system 103 may receive queries, retrieve stored data, and communicate with network 122. While data provider system 103 is illustrated as disparate from network 122, network 122 may include data provider system 103. Data provider system 103 may comprise a plurality of network devices operable to communicate requested data to server system 105 via network 122. For example, data provider system 103 may comprise a plurality of data providers. In the illustrated embodiment, data provider system 103 includes data provider 106.

Data provider 106 typically comprises a third party web server or an enterprise agent residing on a target machine. It will be understood that the target machine may be remote or on-site; further, the target machine may represent a separate process running in server system 105 or client 102 without departing from the scope of this disclosure. Generally, data provider 106 receives data requests 136 from server system 105 and retrieves data from the software product residing on target machine. Once the data has been gathered, data provider 106 may communicate the data to server system 105 or server system 105 may retrieve the data from data provider 106, as appropriate.

Server system 105 provides GUI 116 with embedded data to network 122. Server system 105 may receive client request 135, query data provider 106, receive requested data, generate GUI 116, and communicate with network 122. While server system 105 is illustrated as disparate from network 122, network 122 may include server system 105. Server system 105 may comprise a plurality of network devices operable to communicate response to client system 101 in network 122. For example, server system 105 may comprise a plurality of servers. In the illustrated embodiment, server system 105 includes server 104.

Server 104 includes a network interface 112, a memory 110 and a processor 108 and comprises an electronic computing device operable to receive, transmit, process, and store data associated with system 100. For example, server 104 may comprise a general-purpose personal computer (PC), a Macintosh, a work station, a UNIX-based computer, a server computer, or any other suitable device. According to one embodiment, server 104 may comprise a web server. In short, server 104 may comprise software and/or hardware in any combination suitable to present client 102 with GUI 116, which includes data from one or more data providers 106.

FIG. 1 only provides one example of computers that may be used with the disclosure. For example, although FIG. 1 provides one example of server 104 that may be used with the disclosure, system 100 can be implemented using computers other than servers, as well as a server pool. The present disclosure contemplates computers other than general purpose computers as well as computers without conventional operating systems. As used in this document, the term “computer” is intended to encompass a personal computer, work station, network computer, or any other suitable processing device. Computer server 104 may be adapted to execute any operating system including UNIX, Windows, or any other suitable operating system.

Network interface 112 may facilitate communication with network 122, including client 102 in network 122. In certain embodiments, server 104 may generate server responses 138 to client requests 135 in network 122 to provide GUI 116. Interface 112 calibrates the reception of requests and the transmission of these responses to the requests. Generally, interface 112 comprising the logic encoded in software and/or hardware in a suitable combination and operable to communicate with network 122. More specifically, interface 112 may comprise software supporting one or more communications protocols associated with network 122 or hardware operable to communicate physical signals.

Memory 110 may include any memory or database module and may take the form of volatile or non-volatile memory including, without limitation, magnetic media, optical media, random access memory (RAM), read-only memory (ROM), removable media, or any other suitable local or remote memory component. In this embodiment, memory includes at least GUI descriptor file 114, but may also include any other suitable appropriate data. GUI descriptor file 114 comprises one or more GUI profiles 115. GUI descriptor file 114 may receive GUI profiles 115 through interface 112 or from another process running on server 104. GUI descriptor file 114 may be any suitable format including extensible markup language (XML) documents, flat files, comma-separated-value (CSV) files, relational database tables, or any other format operable to store at least one GUI profile 115.

GUI profile 115 is associated with client 102 based on any appropriate characteristic. For example, server 104 may associate GUI profile 115 based on a selection by client 102 or a user group, client ID, IP address, logical location, a security level, requested data, or any other suitable characteristic of client 102. In general, GUI profile 115 provides an interface between client 102 and server 104 that automatically generates GUI 116 and dynamically formats GUI 116 to receive requested data according to GUI profile 115. GUI profile 115 comprises at least one GUI descriptor element 118, which describes one or more graphical elements 117 and operable to be processed by server 104. GUI profile 115 may be created by client 102, third-party software vendor, or any other appropriate user of the respective product or loaded from a default profile. If an updated or new GUI 116 is desired, creating a new GUI profile 115 may be sufficient, instead of creating an entire GUI 116. GUI profile 115 may be in any electronic format such as, for example, an XML document, CSV file, EFT record, or any other appropriate data format. In one embodiment, XML is used because it is easily portable, human-readable, and customizable. Additionally, GUI profile 115 may provide a consistent look and feel to client 102.

GUI profile 115 includes one or more GUI descriptor elements 118. In general, descriptor elements 118 include various data characteristics and presentation parameters that allow server 104 to automatically generate GUI 116 for client 102. Descriptor elements 118 are associated with one or more graphical elements 117 for display on GUI 116. As discussed above, each graphical element 117 may comprise one or more of the following visual components: frame, table, list, tree, grid, title, tab, tree item, text box, check box, button, table item, list item, scroll bar, or any other item suitable for display to the user of client 102. In one embodiment, description elements 118 of each GUI profile 115 is arranged in a hierarchical structure. In this embodiment, the root node provides information about the general interface and each child represents graphical elements 117 including fields to be populated with retrieved data. In this embodiment, GUI profile 115 may allow structured or hierarchical data presentation.

Processor 108 executes instructions and manipulates data to perform the operations of server 104 such as, for example, a central processing unit (CPU), an application specific integrated circuit (ASIC), or a field-programmable gate array (FPGA). Although FIG. 1 illustrates a single processor 108 in server 104, multiple processors 108 may be used according to particular needs and reference to processor 108 is meant to include multiple processors 108 where applicable. In the illustrated embodiment, processor 108 may execute or process GUI generation engine 120 that automatically dynamically generates GUI 116 based on GUI profile 115. The term “automatically,” as used herein, generally means that the appropriate processing is substantially performed by server 104. The term “dynamically,” as used herein, generally means that the appropriate processing is determined at run-time based upon client requests 135. In one embodiment, GUI generation engine 120 is compatible with Java Server Pages and Struts. GUI generation engine 120 could include any hardware, software, firmware, or combination thereof operable to receive a client's request 135 from client 102, retrieve data from data provider 106, automatically generate GUI 116, and populate GUI 116 with retrieved data. It will be understood that while GUI generation engine 120 is illustrated as a single multi-task module, the features and functionality performed by these engines may be performed by multiple modules such as, for example, a data retrieval module, a transformation module, and a presentation module. Moreover, while not illustrated, GUI generation engine 120 may be a child or submodule of another software application without departing from the scope of the disclosure.

In one aspect of operation, client 102 communicates client request 135 to server 104. Before client request 135 is received by server 104, system 100 may require that client 102 log onto server 104, as appropriate. For example, if system 100 comprises an enterprise security management system, then server 104 may first verify client 102 before accepting client request 135. When server 104 receives client request 135, server 104 loads GUI profile 115 from GUI descriptor file 114 based on one or more characteristics of client request 135.

Server 104 then processes client request 135 to produce GUI 116 with the appropriate data. For example, if server 104 comprises web server components, then server 104 may use the Apache Jakarta Tomcat servlet engine or other suitable module to process client request 135. Based upon client request 135, GUI generation engine 120 communicates server request 136 to data provider 106 in order to retrieve the desired data. According to one embodiment, there may be more than one data provider 106 necessary to fulfill client request 135. After suitable processing, the requested data provider 106 communicates output 137, which comprises requested data. GUI generation engine 120 dynamically generates graphical elements 117 embedded in GUI 116. At which point, generation engine 120 populates available fields in graphical elements 117 with data received from output 137. Once GUI generation engine 120 has fully populated GUI 116 with requested data, GUI 116 is communicated to requesting client 102.

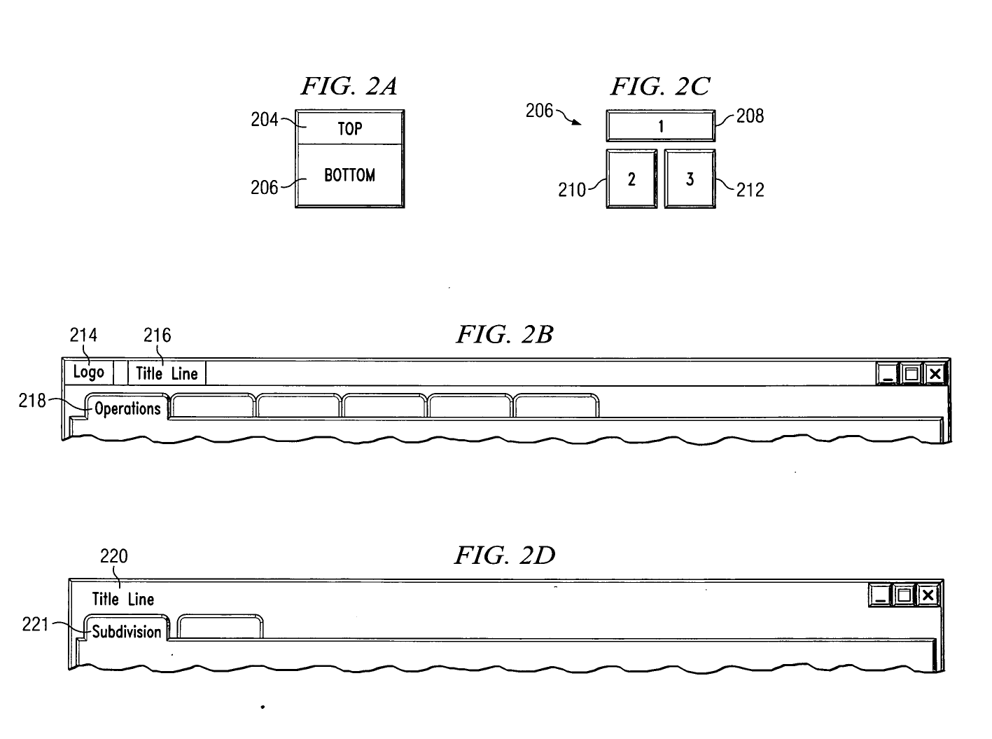

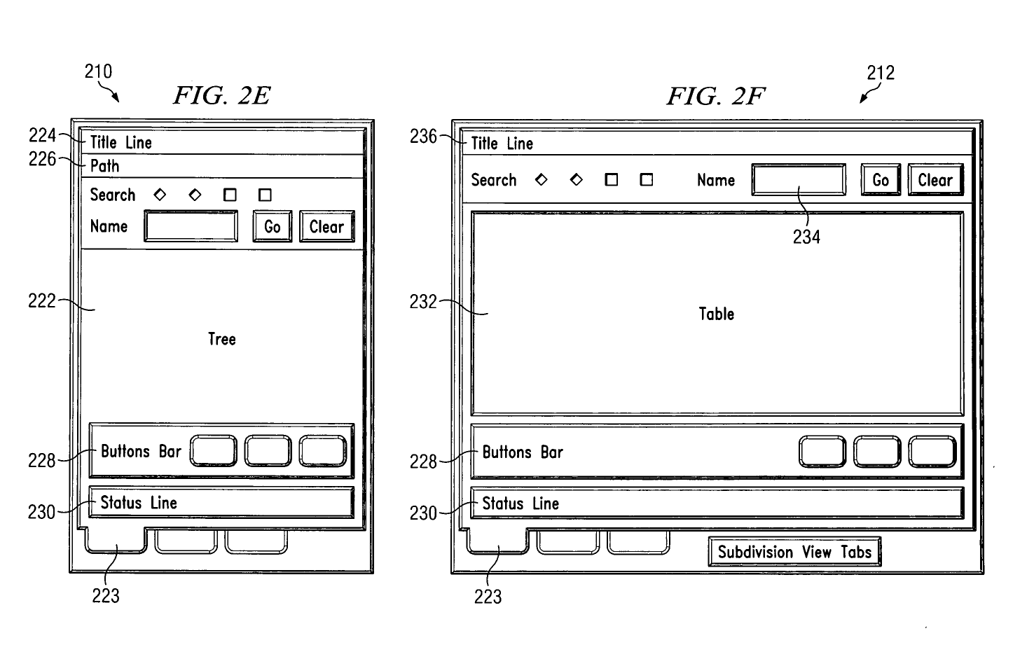

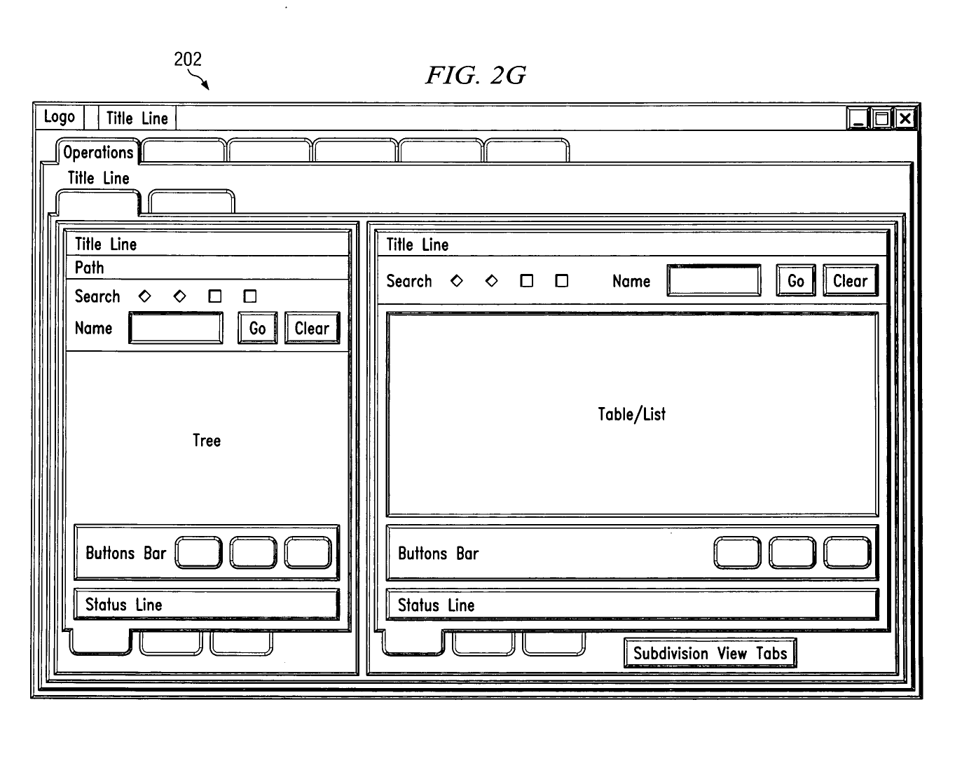

FIGS. 2A-G illustrate one embodiment of data display 202 constructed by GUI generation engine 120 typically providing an efficient and substantively uniform presentation. Generally, GUI generation engine 120 allows server 104 to provide data from data providers 106 to client 102 in a dynamically formatted GUI 116. According to one embodiment, illustrated in FIG. 2A, GUI generation engine 120 constructs a top frame 204 and a bottom frame 206 within which additional graphical elements 117 and data provided from the data provider 106 will be embedded. After initially constructing two frames, GUI generation engine 120 may construct graphical elements 117 embedded in top frame 204, illustrated in FIG. 2B. In the embodiment illustrated in 2B, graphical elements 117 in top frame 204 include logo 214, title line 216, and a plurality of tabs 218. Logo 214 generally displays a company logo. Title line 216 generally displays a text string at the top of top frame 204 and is operable to provide some information regarding a selected application. Application tabs 218 provide a mechanism for client 102 to tab between major application areas in use and each tab 218 may be visible at all times. In this embodiment, GUI generation engine 120 dynamically formats application tabs 218 according to the number of applications in use by client 102.

Bottom frame 206, as illustrated in FIG. 2C, is further subdivided into title section 208, tree section 210, and table section 212. Title section 208 includes bottom title line 220 and application subdivision tabs 221, illustrated in FIG. 2D. Bottom title line 220 typically displays a text string at the top of bottom frame 206 indicating subject matter of bottom frame 206. Application subdivision tabs 221 are located at the top of bottom frame 206 and provide a mechanism for tabbing between hierarchical trees within an application area.

In embodiment illustrated in FIG. 2E, tree section 210 provides a tree view of objects the selected application works with. Tree section 210 may include tree 222, tree title line 224, path field 226, button bar 228, status line 230, and subdivision view tabs 223. Tree 222 allows the user to select different nodes in a logical tree. In one embodiment, tree 222 may be scrollable both vertically and horizontally. The path from the root node to a selected node may be indicated in the path field 226, which may be helpful when part of tree 222 is scrolled out of view. Tree title line 224 normally displays a text string at the top of tree section 210 for providing information regarding tree 222. Button bar 228 provides a plurality of buttons to a user for launching some functionality associated with tree 222, such “Refresh” or other suitable actions. Status line 230 may be used to display additional information such as communication status, messages, or other suitable information associated with the application component selected by tab 218. In one embodiment, subdivision view tabs 223 provide the user a mechanism for altering the view of tree 222. For example, different hierarchies may be based on subnet, platform, version, a special filter tab, or any other means for displaying information associated with application. In another embodiment, subdivision view tabs 223 allow a user to display different sets of objects that the application works with. For example, a “Filter View” tab may restrict the objects displayed in tree 222. In one embodiment, the restrict objects are based on tree object names or other common property (e.g., description). In this embodiment, the “Filter View” tab may preserve the grouping from where the filter option is chosen. In another embodiment, the “Filter View” may only preserve the last filter chosen, so all subsequent filters may be over written on the same tab. In yet another embodiment, a “Filler Dialog” provides a field to enter an expression operable to filter true 222.

Table section 212, as illustrated in FIG. 2F, may include table 232, search field 234, table title line 236, button bar 228, status line 230, and subdivision view tabs 223. Table 232 provides a tabular listing of objects generated from selections in tree 222 or search requests. In one embodiment, table 232 allows single or multiple selections for batch operations. These operations or actions may be driven by button bar 228 at the bottom of table section 212. In this embodiment, a popup window may display a static list of items user has selected, which may be edited. In one embodiment, the popup window comprises an upper and a lower area, wherein the lower area contains a list of objects selected by client 102 and the upper area may define the present application with accompanying Action Buttons. For example, the popup window may be closed to display the selected items in table 232, so numerous changes may be made. If the batch list is multiple pages, the batch operation may have to be run page by page. Search requests may be made by a user through the search field 234. Status line 230 may be used to display additional information such as communication status, messages, or other suitable information associated with the application component selected by tab 218. In one embodiment, subdivision view tabs 223 provide the user a mechanism for altering the view of table 232. For example, different tables may be based on subnet, platform, version, a special filter tab, or any other means for displaying information associated with application. In another embodiment, subdivision view tabs 223 allow a user to display different sets of objects that the application works with. Button bar 228 may popup a new frame, overlay the list, or provide other suitable graphical elements 117 for conveying information. Common graphical elements 117 provide a consistent look and feel as well as consistent behavior of GUI 116.

In one aspect of operation, a user of client 102 selects an application by clicking on one of the application tabs 218. Selecting application tab 218 may trigger a change in bottom frame 206 or completely refresh bottom frame 206. In one embodiment, a default view of the selected application is provided in bottom frame 206 when application tab 218 is initially selected. In this embodiment, tree section 210 may first provide a default view of tree 222 with the root node selected. Selecting an object in tree 222 may result in a default view of that node in table section 212, which may be in table/list form. For example, if “Queue Managers” node is selected in tree 222 then table section 212 may display a list of Queue Managers. Button Bar 228 of table section 212 may provide actions to be performed on these objects in table 232. For example, ‘Delete’ button may delete a selected Queue Manager from table 232.

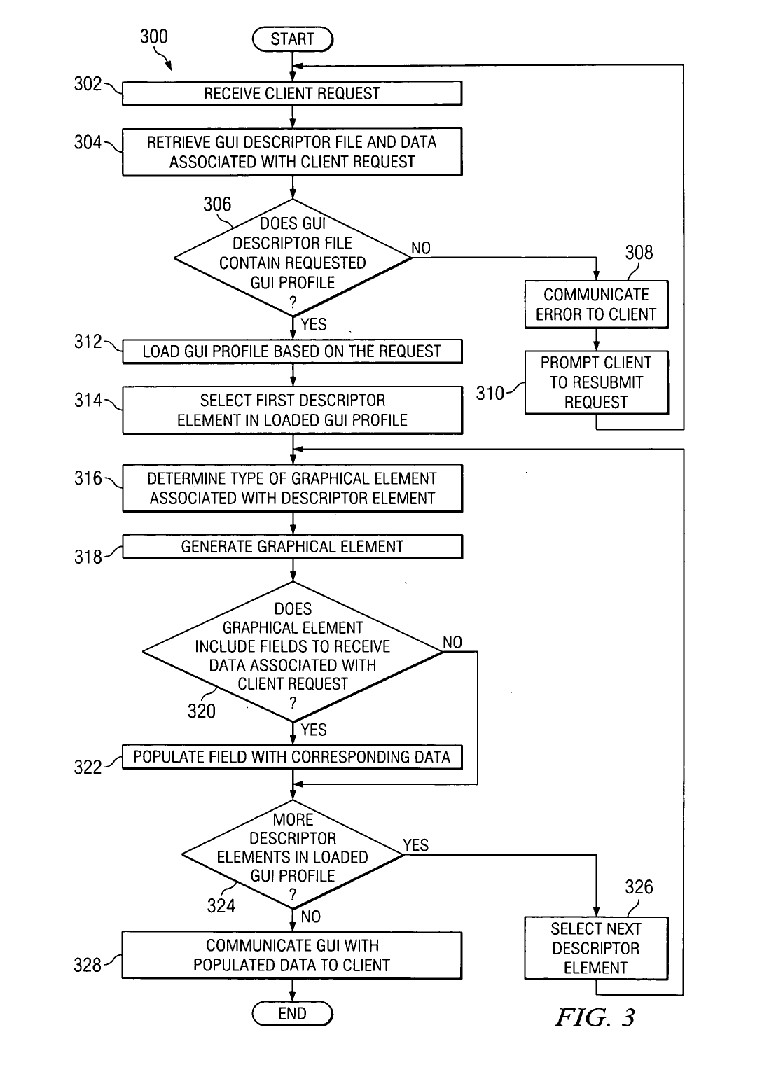

FIG. 3 illustrates a flowchart of an exemplary method 300 for automatically retrieving requested data into a dynamic format such as a data display 202 to client 102 using a GUI profile 115. Method 300 is described in respect to system 100. However, any other suitable system may use method 300 to dynamically create and provide data display 202 without departing from the scope of this disclosure. Generally, method 300 describes server 104 loading GUI profile 115 associated with client request 135 and dynamically creating GUI 116 using GUI profile 115.

Server 104 receives client request 135 from client 102 via network 122 at step 302. At step 304, server 104 retrieves GUI descriptor file 114 from memory 110 and server 104 retrieves requested data from data provider 106. At decisional step 306, GUI generation engine 120 determines whether GUI descriptor file 114 contains requested GUI profile 115. If GUI descriptor file 114 does not contain the requested GUI profile 115, then server 104 communicates an error message to client 102 at step 308. Additionally, server 104 prompts client 102 to resubmit client request 135 at step 310, at which point method 300 returns to step 302. If GUI descriptor file 114 does contain the requested GUI profile 115 then server 104 loads GUI profile 115 containing descriptor elements 118 which are associated with client request 135 at step 312.

Server 104 selects a first descriptor element 118 in GUI profile 115. In one embodiment, the first descriptor element 118 is a root node in an XML file comprising information regarding a general interface. Next at step 316, GUI generation engine 120 determines a type of graphical element 117 associated with the first descriptor element 118. Next, at step 318, GUI generation engine 120 dynamically constructs graphical element 117 associated with descriptor element 118 and GUI profile 115.

At decisional step 320, GUI generation engine 120 determines whether corresponding graphical element 117 includes fields to receive data associated with client request 135. If graphical element 117 does include fields to receive data associated with client request 135, each field is populated with the corresponding data retrieved from data provider 106. If graphical element 117 does not include fields to receive data associated with client request 135, the method 300 proceeds to decisional step 324. At decisional step 324, GUI generation engine 120 determines whether there are more descriptor elements 118 to be loaded from GUI profile 115. If there are more descriptor elements 118 to be loaded from GUI profile 115, then method 300 proceeds to step 326. At step 326, GUI generation engine 120 selects the next descriptor element 118 from GUI profile 115. If there are no more descriptor elements 118 to be loaded from GUI profile 115, then server 104 communicates GUI 116 with populated data to client 102 via network 122 at step 328.

Although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

1. A method for dynamically generating a graphical user interface (GUI), comprising:
selecting a GUI profile from a GUI descriptor file based on a client request, the GUI profile comprising at least one descriptor element;
automatically generating a GUI based on at least a portion of the selected GUI profile; and
populating the GUI with data based, at least in part, on the client request.

2. The method of claim 1, the GUI descriptor file comprising an eXtensible Markup Language (XML) file.

3. The method of claim 1, wherein generating a GUI based on the retrieved GUI descriptor file comprises generating a HyperText Markup Language (HTML) page.

4. The method of claim 1, the portion of the GUI profile comprising a first and a second descriptor element, the second descriptor element comprising a child of the first descriptor element.

5. The method of claim 4, further comprising:
generating a first graphical element based on the first descriptor element; and
generating a second graphical element based on the second descriptor element, the second graphical element embedded in the first graphical element.

6. The method of claim 5, further comprising altering the second graphical element based on the data to be populated in the second graphical element.

7. The method of claim 1, the client request comprising a GUI identification (ID) and wherein selecting a GUI profile in response to a client request comprises selecting the at least a portion of the selected GUI profile based on the GUI ID.

8. The method of claim 1, each descriptor element associated with a graphical element selected from the group consisting of a frame, a table, a list, a tree, a grid, a title, a tab, a tree item, a text box, a check box, a button, a table item, a list item, a scroll bar, and a combination of the foregoing.

9. The method of claim 1, the client request comprising data source information and the method further comprising retrieving data based on the data source information.

10. The method of claim 9, the data source information comprising an Internet Protocol (IP) address and wherein retrieving data based on the data source information comprises retrieving data from the IP address.

11. Software for dynamically generating a GUI, the software operable to:
select a GUI profile from a GUI descriptor file based on a client request, the GUI profile comprising at least one descriptor element;
automatically generate a GUI based on at least a portion of the selected GUI profile; and
populate the GUI with data based, at least in part, on the client request.

12. The software of claim 11, the GUI descriptor file comprising an XML file.

13. The software of claim 11, wherein software operable to generate a GUI based on the retrieved GUI descriptor file comprises software operable to generate an HTML page.

14. The software of claim 11, the portion of the GUI profile comprising a first and a second descriptor element, the second descriptor element comprising a child of the first descriptor element.

15. The software of claim 14, further comprising software operable to:
generate a first graphical element based on the first descriptor element; and
generate a second graphical element based on the second descriptor element, the second graphical element embedded in the first graphical element.

16. The software of claim 15, further comprising software operable to alter the second graphical element based on the data to be populated in the second graphical element.

17. The software of claim 11, the client request comprising a GUI ID and wherein the software operable to select a GUI profile in response to a client request comprises software operable to select the at least a portion of the selected GUI profile based on the GUI ID.

18. The software of claim 11, each descriptor element associated with a graphical element selected from the group consisting of a frame, a table, a list, a tree, a grid, a title, a tab, a tree item, a text box, a check box, a button, a table item, a list item, a scroll bar, and a combination of the foregoing.

19. The software of claim 11, the client request comprising data source information and the software further operable to retrieve data based on the data source information.

20. The software of claim 19, the data source information comprising an IP address and wherein the software operable to retrieve data based on the data source information comprises software operable to retrieve data from the IP address.

21. A system for dynamically generating a GUI, comprising:
memory operable to store information associated with a plurality of network elements in the enterprise system; and
one or more processors collectively operable to:
select a GUI profile from a GUI descriptor file based on a client request, the GUI profile comprising at least one descriptor element;
automatically generate a GUI based on at least a portion of the selected GUI profile; and
populate the GUI with data based, at least in part, on the client request.

22. The system of claim 21, the GUI descriptor file comprising an XML file.

23. The system of claim 21, wherein the one or more processors operable to generate a GUI based on the retrieved GUI descriptor file comprise one or more processors operable to generate a HTML page.

24. The system of claim 21, the at least a portion of the GUI profile comprising a first and a second descriptor element, the second descriptor element comprising a child of the first descriptor element.

25. The system of claim 24, the one or more processors further operable to:
generate a first graphical element based on the first descriptor element; and
generate a second graphical element based on the second descriptor element, the second graphical element embedded in the first graphical element.

26. The system of claim 25, the one or more processors further operable to alter the second graphical element based on the data to be populated in the second graphical element.

27. The system of claim 21, the client request comprising a GUI ID and wherein the one or more processors select a GUI profile in response to a client request comprise one or more processors select the at least a portion of the selected GUI profile based on the GUI ID.

28. The system of claim 21, each descriptor element associated with a graphical element selected from the group consisting of a frame, a table, a list, a tree, a grid, a title, a tab, a tree item, a text box, a check box, a button, a table item, a list item, a scroll bar, and a combination of the foregoing.

29. The system of claim 21, the client request comprising data source information and the processors further operable to retrieve data based on the data source information.

30. The system of claim 29, the data source information comprising an IP address and wherein the one or more processors retrieve data based on the data source information comprise one or more processors retrieving data from the IP address.

31. A method for generating a graphical user interface (GUI), comprising:
selecting a GUI profile from a GUI descriptor file based on a client request, the client request comprising data source information, the GUI descriptor file comprising an XML file, the GUI profile comprising a first and second descriptor element;
retrieving data based on the data source information;
automatically generating a GUI based on at least a portion of the selected GUI profile;
generating a first graphical element based on the first descriptor element;
generating a second graphical element based on the second descriptor element, the second graphical element embedded in the first graphical element; and
populating the GUI with data based, at least in part, on the client request.
